(19) United States
(12) Patent Application Publication
(10) Pub. No.: US 2025/0273352 A1
(43) Pub. Date: Aug. 28, 2025

(54) Free Energy

(71) Applicant: David Andrew D'Zmura, San Diego, CA (US)

(72) Inventor: David Andrew D'Zmura, San Diego, CA (US)

(21) Appl. No.: 18/445,837

(22) Filed: Feb. 28, 2024

(51) Int. Cl. G21B 1/05

(52) U.S. Cl. CPC G21B 1/057

(57) ABSTRACT

A process producing an inner product of mass and energy, this process a prime cause of universal expansion. The mass, convertible to energy, is created in a tokamak apparatus system.

### RELATED, PRIORITY APPLICATION

This application is a Continuation-In-Part of my U.S. Non-Provisional patent application Ser. No. 17/803,107, entitled “C. P. L. T. and Free Energy” of which I am sole inventor/applicant.

### TECHNICAL FIELD

The invention is situated in the field of physics, both large-scale as well as quantum, focusing on energy functionality. The invention establishes the process for matter generation, which can be converted to its energy characteristic, as free energy.

### BACKGROUND OF THE INVENTION

A tokamak is an apparatus utilizing strong magnetic fields to confine plasma in the shape of a donut, in the shape of a torus. The word “tokamak” comes from “toroidal chamber with magnetic coils”. A “divertor” is part of a tokamak, which causes heavy elements to be cast out parting the heavy elements from the toroidal chamber. The magnetic field coils confine plasma particles, one set of magnetic coils generates a toroidal field (the long way around the torus), and a second magnetic field creates a poloidal direction (the short way around the torus).

The two fields result in capability to twist the magnetic field impacting particles in the torus. In a further development, a third set of field coils can generate an outer poloidal field. The fuel typically used in tokamaks is a 50/50 mix of deuterium and tritium. Magnetic compression is the technique used to create ultra-hot temperatures. One increases the confining magnetic field to compress the plasma and cause it to heat.

### BRIEF DESCRIPTION OF THE DRAWINGS

FIGS. 1 and 2, are the process of generating Free Energy, which is a created offshoot from the cycling of time, and causes the expansion of the universe, through the creation of matter and dark matter.

FIG. 3 represents the two states, large scale and quantum, by E=mc² and e=mc, respectively. The process interfacing said two states are governed by the formulas for K and k. Duration, a measure of time, has clock speed of K rendered per the speed of light.

FIG. 4 shows the programming of the tokamak, wherein the plasma is shaped to the poloidal and then over to the toroidal field, then to the middle, the zero value, this repeating.

### DETAILED DESCRIPTION OF THE INVENTION

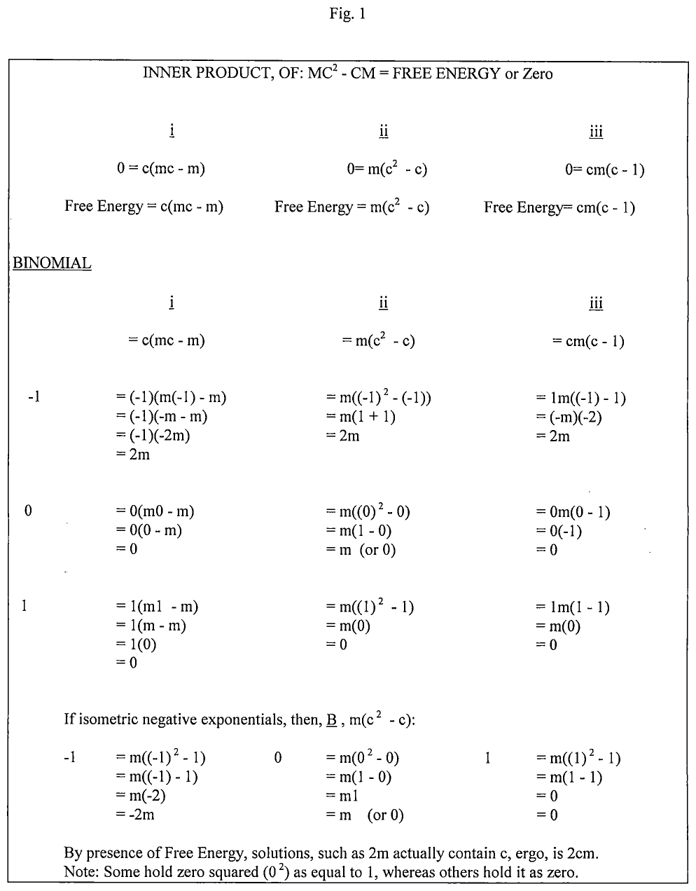

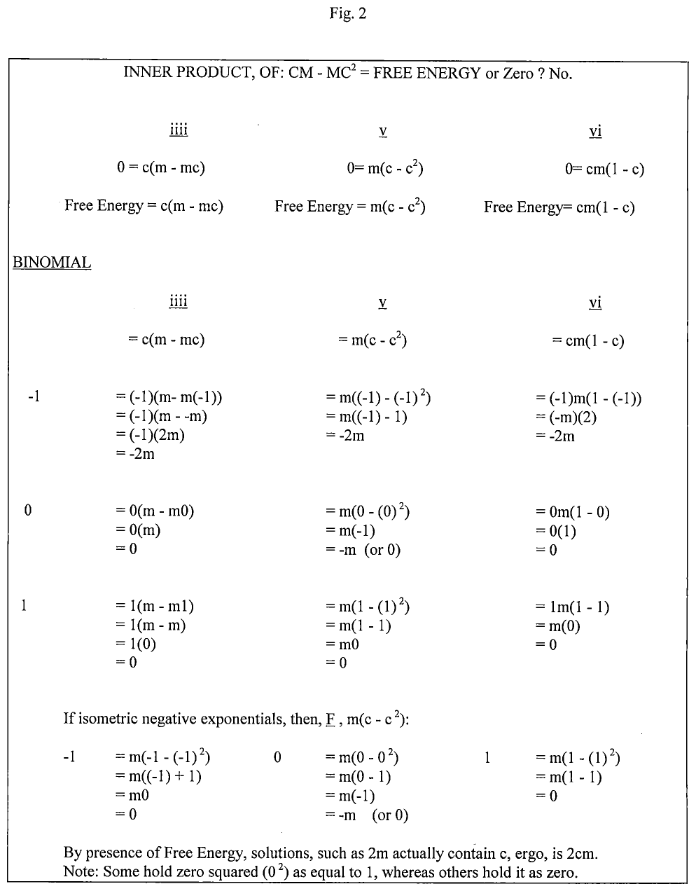

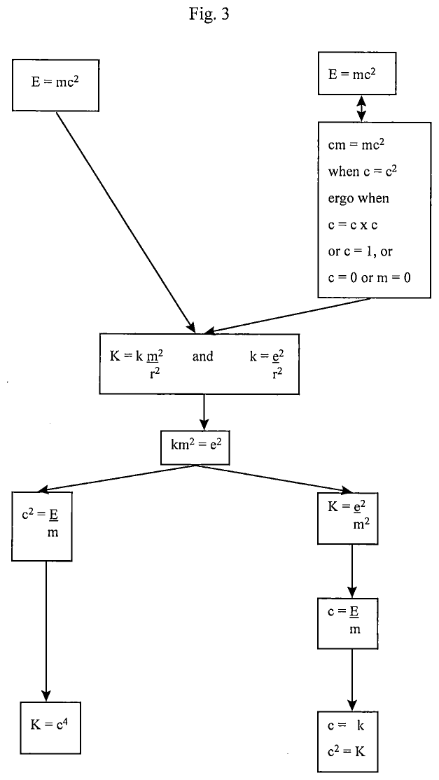

The invention renders the process creating matter and dark matter through the cycling in time of the two states, large-scale and quantum. For each of the states, a formula of energy is said to hold. For the large-scale state, the formula is E=mc². For the quantum state, the formula is e=mc. The quantum state departs because the speed of light is a constant, and in natural units is 1, wherein 12=1. Another reason is there is no speed faster than the speed of light, such that lim c²=c. These two causes result in the conditions of equality between E=mc², and, e=mc. Using the speed of light as 1, 0 (absence of light), and −1 (dark light), one can assess the result of the cycling of the states, using subtraction of one state's formula from the other, this is the substance of FIGS. 1 and 2. What is produced is 2m per cycle caused by dark light (−1) for the subtraction, mc²−mc. For the subtraction, cm−mc², again caused by dark light (−1), is −2m (two units of dark matter) produced per cycle. This is a prime force causing expansion of the galaxy and universe. The cycling of the states is governed by the formulas for K (large-scale) and k (quantum), duration over time, with these formulas given in FIG. 3. Duration is also shown as given in terms of the speed of light.

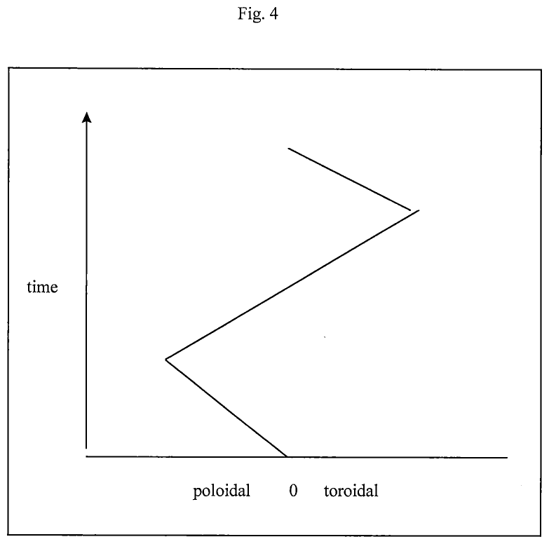

The environment for deployment of this technology is made feasible by, for instance, a tokamak. The invention herein is the programming of the magnetic field coils to create an alternating, a subtraction, line, from a zero neutral line, to the poloidal side, then back to neutral then over to toroidal side, then back to zero neutral, then indefinitely repeating the movement, whereby generating 2m mass per cycle, depositing said generated mass into the divertor to remove said mass rather than to have it remain in system. See FIG. 4.

What I claim is:

1. A process producing an inner product, occurring between the two states, large-scale and quantum, wherein having the governing formulas, E=mc² and e=mc, respectively, said inner product produced by cycling of these two said states, in both directions, causing to be directed by mc²−mc, and by mc−mc², wherein said inner product is rendered by solving for the constant speed of light in natural units, whereby a binomial is formed of one or zero, or alternately, negative one, producing 2m per cycle and −2m per cycle, respectively, under dark light/energy, otherwise, zero, said process occurring in an apparatus system of a tokamak, wherein programming flow line, between toroidal and poloidal, repeating an alternating signature, from zero neutral to poloidal back to neutral, then to toroidal and then back to zero neutral, then repeating this indefinitely subject to shutoff.

2. In the invention of claim 1, which further comprises the duration, change respective time, governing said process. producing said inner product: for large-scale state, K=k(m²/r²); and for quantum state, k=e²/r².

3. In the invention of claim 1, which further comprises duration in terms of the speed of light, wherein: for large-scale state, K=c⁴; and for quantum state, √k=c, and K=c².
